(19) United States
(12) Patent Application Publication
(10) Pub. No.: US 2006/0262903 A1
(43) Pub. Date: Nov. 23, 2006

(54) Method and apparatus for photothermal modification of x-ray images

(76) Inventor: Roger M. Diebold, Barrington, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/134,180

(22) Filed: May 20, 2005

(51) Int. Cl. G01N 23/04

(52) U.S. Cl. 378/62

(57) ABSTRACT

An x-ray image of a body can be modified by absorption of laser radiation that causes thermal gradients to be generated in portions of the body. If an object within the body has a higher optical absorption than the surrounding medium, the effect of absorption of the laser radiation is to cause the production of thermal gradients. Thermal gradients give rise to density gradients, which modify an x-ray image through changes in x-ray index of refraction at the site of the thermal gradient. The overall effect of the laser heating is to produce an x-ray contrast mechanism wherein the x-ray image becomes sensitive to differences in the optical absorption within a body. An application of the invention is for detection of tumors that are highly vascularized, using a laser operating in the near infrared.

### BACKGROUND OF THE INVENTION

The present invention relates generally to imaging and non-destructive testing through use of x-radiation. The laser produces thermal gradients wherever there is optical contrast, i.e. different optical absorption coefficients, between objects within a body and the surrounding material in the body. The method has application to non-destructive testing where a body scatters optical radiation (so that no clear image can be made), but which has differential absorption between parts within the body whose image is sought. One application of the method is to tissue imaging such as x-ray mammography where tissue scatters optical radiation strongly, so that a clear optical image cannot be formed, but which does not completely absorb the optical radiation. X-rays penetrate tissue and can form a sharp image. In the case of tissue, the method makes the x-ray image sensitive to the presence of blood, blood vessels, and tumors, all of which have significant optical contrast relative to the surrounding tissue and which will cause the formation of thermal gradients when an optical source irradiates the body.

Principles of X-ray Imaging

The use of x-radiation in imaging dates back to its discovery by Roentgen in the nineteenth century. The x-ray imaging invented by Roentgen, and which is commonly used in medical diagnosis, such diagnosis of bone fracture, is based on differential absorption of the x-rays as they pass through a body. Typically, the object of interest, the bone in the present example, has a higher electron density (through its different chemical composition) than the surrounding muscle tissue resulting in stronger absorption of the x-rays in the bone than in the surrounding muscle. Hence, a shadow of the bone is recorded in the x-ray image. The method of image formation based on differential absorption of x-radiation can be called “shadography”. The contrast mechanism in such x-ray images is provided by differential absorption of the x-rays passing through the body. A powerful technique for improving contrast in an x-ray image is to use a contrast agent such as a heavy metal, the most common being Ba. On a per mole basis, Ba will absorb more x-radiation than the common elements making up tissue, such as C, H, and O as a result of its overall higher electron density. In the case of medical imaging, if a contrast agent such as a barium salt is injected into the venous system (and remains in the veins, not being absorbed in surrounding tissue), then the increased absorption of the of the barium relative to the surrounding tissue results in a strong differential absorption of the x-rays passing through the body so that the x-ray image shows the veins as nearly opaque in comparison with the surrounding tissue.

Recently, several research groups have shown that x-ray images can be produced where the contrast mechanism in the image is produced by an altogether different mechanism, differences in index of refraction. That is, the differential phase changes that the x-radiation experience in traversing a body can be recorded giving a phase image of the body. The methods of recording the phase changes, at present, rely on deflection or interference effects to cause addition or subtraction of the wave amplitudes resulting in intensity variations that are recorded in the image. Several methods of phase-contrast imaging have been explored.

Wilkins and coworkers (Wilkins et al., 1996) introduced an “in line” method where a near point source (approximately 20 μm diameter) of x-radiation illuminates a body located a distance R₁ from the source, and an image is recorded at a distance R₂ from the body, giving a magnification R₁/(R₁₊R₂) to the image. The resolution and contrast in such a method of image formation is described by Wilkins et al., 1966, and Pogany et al. 1997. The method, surprisingly, has only a weak dependence on wavelength, and can give images with polychromatic x-ray sources. From a simplified viewpoint, the in line method can be said to rely on deflection of the x-rays caused by changes in index of refraction within a body, it is the deflection of the rays that causes light and dark regions to be produced in the image. From this perspective, there can still be image formation even when there is no absorption in the body.

A rigorous mathematical description of in line phase contrast imaging has been given. According to Pogany et al. the intensity recorded in the image I(x), for a pure phase object in a one dimensional problem, in the limit of small u′=(λz)^{1/2}u, where λ is the wavelength of the x-radiation, z is the sample to image distance and u is the spatial frequency is given by
I(x)=1+(λz/2π)φ″(x)
where φ″(x) is the second space derivative of the phase undergone by the x-rays in traversing the body. Equation 1 shows that the intensity, or more explicitly, the contrast, recorded in the x-ray image is proportional to the second space derivative of the phase experienced by the x-ray beam in traversing the body. Thus, the phase variations in the body are recorded as intensity variations in the x-ray image. Of course, as is shown by the same authors, absorption features also appear in the image for an object that both absorbs and contributes phase changes to the x-radiation. Equation 1 for a body with varying density p can be recast in terms of the second space derivative of the density as
I(x)=1+(λ²rₑz/2π)ρ″(x)
where ρ″(x) is the second space derivative of the density, and rₑ is the classical radius of the electron. Equation 2 shows that the second space derivative of the density, that is, density gradients, are recorded as intensity variations in the x-ray image. It follows that in addition to natural density variations in a body, any externally induced density variation within a body will affect an x-ray image.

In general, when the parameter u′ is not small, as Pogany et al. show, the intensity in the image can be a more complicated function of the phase changes induced by the body. The important point though is that density gradients in a body, even where there is no absorption, give rise to the intensity variations in the recorded image, which corresponds to a contrast mechanism in additional to the usual absorption which is the basis for shadowgraphy. Phase contrast x-ray images record phase variations that can be inherent in the makeup of the body, or induced by some external means.

Another method of recording the phase change of x-radiation has been described by Bonse and Hart who use a block of single crystal Si to produce the x-ray equivalent of a Michelson interferometer. Objects placed in one arm of the interferometer modify the phase of the x-radiation in that arm only, resulting in the registration of the phase changes experienced by the x-rays passing through the body at the point where the two beams of x-rays are combined and interfere to produce an image.

Davis et al. use a slit combined with a beam expander and collimator crystal to produce a nearly plane wave of x-radiation. The body is placed in the beam introducing phase changes, as well as absorption, in the x-ray beam. The x-ray beam with the “distortions” arising from varying indices of refraction from objects within the body is directed onto two crystals and then onto x-ray film or a detector to produce an image. Again, it is phase change introduced by the body that gives rise to contrast in the image.

A further option to record phase variations in a body is to use a phase plate to focus a beam of x-rays onto a body, as described by McNulty et al. The phase plate (also known as a zone plate) provides a reference wave that interferes with the radiation that passes through the body and produces a hologram that is recorded on film or a digital device such as a charge coupled device (CCD) camera. The recorded hologram of the body is reconstructed with a mathematical algorithm, such as a Fourier transform, to give the image of the body. Again, the method records phase changes of the radiation as it passes through the body.

### BRIEF SUMMARY OF THE INVENTION

In this regard, the present invention is directed to photothermal modulation of X-ray images.

Effect of Heat Deposition on an X-ray Image

The index of refraction n of a body in the x-ray region of the spectrum is given by
n=1−δ−iβ
The imaginary part of the index describes β describes x-ray absorption; the real part δ describes the phase shift suffered by the x-radiation as it passes through tissue. These components are determined, in turn, by

$$δ = \frac{{r}_{e} {λ}^{2} {N}_{A} ( Z + {f}^{′} )}{2 π A} ρ$$

$$β = \frac{{r}_{e} {λ}^{2} {N}_{A} {f}^{″}}{2 π A} ρ$$

rₑ is the electron radius, NA is Avogadro number, A is the atomic mass, λ is the x-ray wavelength, and f′ and f″ are the real and imaginary components of the atomic scattering factors.

It can be seen that modification of the density profile in a body can result in changes in both the real and imaginary part of the index of refraction of the body. The former determines the phase of the x-rays as they traverse a body and hence their angular deflection as they leave the body. The imaginary part of n determines the absorption of the x-rays as they traverse the body.

From Eqs. 3 and 4 it follows that variations in density provide a variation in both δ and β. Since the contrast in phase contrast imaging is proportional to the second space derivative of φ or ρ according to Eqs. 1 and 2, the modulation of the density through the mechanism of optically induced heating gives a mechanism for modifying an x-ray image.

Photothermal Formation of a Volume Change and a Density Gradient

When a pulse of electromagnetic radiation (hereinafter referred to light or optical radiation to avoid confusion with x-radiation also used in the description of this invention) is absorbed by matter, heating takes place, and with only rare exception, the matter expands. The wavelength of the electromagnetic radiation can be variable, and may be in the visible, ultraviolet, infrared, radiofrequency, or microwave region of the spectrum; absorption of such radiation gives rise to a temperature increase, which leads to expansion. Consider an absorbing object located inside an essentially transparent body of interest. If a short pulse of light is directed into the body, its absorption by the object gives rise to a temperature increase in the object. Since the object is imbedded within the body, the increase in temperature of the object is transmitted to the material in the surrounding body through the mechanism of heat conduction. For a short pulse of light, strong temperature and density gradients are produced at the interface between the absorbing and non-absorbing matter. In accord with the discussion above, such density gradients can contribute to the overall phase change that x-radiation undergoes on traversing the body. The mechanisms of index of refraction or size change in the object are as follows:

First Mechanism: Thermal conduction of heat from warm to colder regions in a body where there are optical inhomogeneities, i.e. different optical absorption coefficients between the object and body will result in density changes from thermal expansion and hence phase gradients that according to Eq. 2, will result in intensity variations in the recorded x-ray image.

Second Mechanism: Ordinary thermal expansion increases the volume of the heated object resulting in a larger object, which, depending on the resolution of the x-ray apparatus will show up in the image as a change in the size of the object.

Third Mechanism: The increase in the temperature of a body induces changes in the index of refraction of the body, independently of a change of density, as is well known in the optical region of the spectrum.

The first mechanism is the most direct process for forming the contrast in the x-ray image. However, if the optically induced temperature rise is large enough, the Second and Third Mechanisms may become large. Depending on the size of the thermally induced change to the density and hence to the index of refraction, a conventional x-ray source not employing microfocus electron optics may be sensitive enough to record the perturbation induced by the heat addition.

The first effect of the absorption of a short burst of optical radiation is a temperature increase and a consequent increase in the dimensions through ordinary thermal expansion in the absorbing region of the body. The temperature gradient gives rise to a corresponding density gradient the size of which is determined by both the size of the temperature gradient and the thermal expansion coefficient of the material heated. When a short burst of radiation first is absorbed, the temperature and density gradients at the interface between the strong and weakly absorbing regions of the body are large, and localized over a short distance. As time progresses, the heat deposited from the optical source diffuses over a progressively longer distance so that the temperature and density gradients become smaller, but are spread over a larger region of space; finally, for long times, the temperature in the body equilibrates and the density gradients disappear.

The largest x-ray contrast effects, according to Eq. 1 or 2, are when the density gradients are the largest. However, the x-ray imaging apparatus should have a resolution high enough to resolve the distance over which the gradient is present. At longer times the gradient is spread over a longer distance, and hence is easier to resolve, but its magnitude is smaller. Thus, in optimizing the effect of the gradients on the x-ray image there is a tradeoff between a large contrast effect over a small length scale requiring high x-ray resolution, and a small effect over a much larger distance requiring lower x-ray resolution. As heat is conducted, density changes are produced in response to the temperature changes.

In the First Mechanism, it is the gradient of the density at the interface of parts of the body with different optical absorption coefficients that causes deflection of the x-rays, or equivalently, the production of a phase change. The change in the overall size of the object of interest as a result of a temperature increase, described as the Second Mechanism, will be recorded in the x-ray image at a time when the object has had time to expand and will be registered in the x-ray image provided the resolution of the x-ray imaging system is sufficiently high. The change in x-ray image with an increase in temperature described as the Third Mechanism takes place on the time scale of the optical excitation, essentially within a time required for molecules to transfer their excitation into heat.

In the present invention, the object of irradiation of the body with pulses of optical radiation is to produce density gradients in the body demarking the presence of differences in optical absorption so that such differences can be recorded in the x-ray image. For example, in examination of mammary tissue it is known (see Oraevsky et al.) that radiation with a wavelength of approximately one micron is absorbed more strongly by blood than by mammary tissue. In Oraevsky's photoacoustic experiments, a pulsed 1.06 μm laser with a few nanoseconds duration is fired at a breast, or a phantom of a breast. The optical radiation is diffused strongly by the mammary tissue, but on reaching a tumor that is highly vascularized and hence possesses a high blood content, the radiation is preferentially absorbed by the blood leading to a heating and a pressure increase at the site of the tumor. The rapid pressure increase in the volume where optical absorption takes place causes an outward going pressure wave to be launched that can be detected by an array of transducers located a short distance from the breast permitting an acoustic image to be produced. It is important to note that in the present invention and in photoacoustic detection, the optical radiation is strongly diffused by the breast tissue; however, the directionality of the optical radiation is of no consequence, it is nevertheless absorbed. The difference in absorption between tumors with their high blood content and healthy tissue at near infrared wavelengths provides reasonably good contrast for images formed in both the photoacoustic method and the present invention.

Other workers in the field of imaging (see Kruger) use a burst of microwaves to excite a photoacoustic effect, again carrying out imaging by detection of the ultrasonic field with an array of transducers. They term their method “thermoacoustic” imaging, but the process is the same as the photoacoustic technique. Again, the contrast mechanism for tumors imaging is provided by the microwaves that are preferentially absorbed by the tumors.

Insofar as the present invention is concerned, for application to tumor and blood detection, the same optical contrast mechanism used by Oraevsky and coworkers as well as Kruger is operative: the differential absorption of radiation (at whatever wavelength in the spectrum it is chosen) is used to create temperature and density gradients between strongly and weakly absorbing regions of the body in the present invention, not to cause a photoacoustic effect, but rather to change the index of refraction of the body for x-rays. The common point between photoacoustic imaging and the present method is that both rely on differences in absorption of the optical radiation to produce a desired effect. For any application of the invention in non-destructive testing or imaging for any purpose, the wavelength of the optical radiation is chosen on the basis of differential absorption between the body and the object within the body to be imaged. The object of the irradiation of the body with optical radiation is to induce thermal and density gradients in the body that influence the x-ray image.

X-Radiation Sources

The radiation source for phase contrast imaging must produce an x-ray beam with a high degree spatial coherence. In the case of x-ray tubes, the required degree of spatial coherence is generally produced by designing the electron focusing optics to provide a small beam diameter resulting in a source size at the anode with linear dimensions on the order of a few microns, typically less than 50 microns. The resulting x-ray source yields an approximation to a spherical wave. A second source of x-rays that has provided suitable beams for phase contrast imaging is a synchrotron designed for x-ray production. The synchrotron x-ray source gives an x-ray beam that approximates a plane wave. In either the case of the microfocus x-ray tube or the synchrotron, the degree of spatial coherence is high, but finite. Excellent images have been produced using either source. Of course, the ideal x-ray source for imaging, especially for the method described here, would be an x-ray laser. Any x-ray laser, even if it is superfluorescent, is expected to have an inherently high degree of spatial coherence.

The only significant difference between a conventional x-ray source and a microfocus source is the dimensions of the source. Conventional x-ray sources can have source dimensions on the order of 100 microns to millimeters. Irrespective of the source, x-rays will be phase modulated photothermally. A density gradient deflects x-ray photons independently of the spatial characteristics of the source. For especially large photothermal effects, the beam from a conventional x-ray tube, even if its spatial coherence is not great, will suffice to generate images with photothermal contrast. The fact that contrast in the x-ray image is formed by absorption and scattering of x-radiation in a conventional x-ray shadowgraph does not preclude a large photothermal effect from adding a new contrast mechanism. The guiding principle in the photothermal mechanism of modifying a conventional x-ray image is that the photothermal change must be large enough to yield a significant perturbation in the image, and the x-ray imaging apparatus must possess a resolution commensurate with the length scale over which the thermal perturbation is generated.

Image Enhancement Through Subtraction

In the present invention, the application of optical radiation to the body should be synchronized with the x-ray burst (or the recording of the image) so that image formation takes place when the gradients are maximal. Thus employment of pulsed sources of optical and x-radiation synchronized in their firing optimizes the visualization of the photothermal effects in the image.

In a preferred embodiment of the invention, an image, or number of images are acquired and added when the optical and x-ray pulses are synchronized to provide the maximum change in the image. Then, a second image or set of images is acquired and added without the optical pulses. Subtraction of the two images gives a difference image that highlights the photothermal effects and minimizes the features of the image that are not affected by the absorption of optical radiation. The same result as modulating the x-ray source can be obtained with a continuous x-ray source by gating the signal to the image forming device with, for instance, a gated image intensifier.

A second preferred embodiment of the invention, essentially a frequency domain version of the invention, uses continuous optical and x-ray sources that are amplitude modulated and synchronized. Again, the synchronization of the x-ray and optical intensities with both having the same phase, i.e. both on at the same (or nearly the same) time, gives an image with the photothermal perturbation maximized. A second image, taken with a phase difference of 180 degrees, between the x-ray and optical sources is recorded. Image subtraction then gives an x-ray image that highlights photothermal effects.

As in the frequency domain embodiment above, in a third preferred embodiment of the invention the x-ray source need not be modulated, but rather, the modulation of the x-ray source is effected in the image by gating the light to the image recording device. Image intensifiers can have very fast turn and turn off times that make them operate as light switches; thus the x-ray beam need not be modulated precisely since the synchronization of the image recording device with the optical source can be carried out with a modulator such as a gated image intensifier. In effect, the gated image intensifier can be triggered to record an image only at the time when the density gradient is optimal.

Other objects, features and advantages of the invention shall become apparent as the description thereof proceeds when considered in connection with the accompanying illustrative drawings.

### BRIEF DESCRIPTION OF THE DRAWINGS

In the drawings which illustrate the best mode presently contemplated for carrying out the present invention:

FIG. 1 is a schematic diagram of the apparatus of the present invention; and

FIG. 2 is a schematic diagram of an alternate embodiment of the apparatus of the present invention.

### DETAILED DESCRIPTION OF THE INVENTION

Referring now to the drawing, the elements comprising a preferred embodiment of the apparatus comprising the invention consists of an x-ray source 1, a body to be examined 2, and a CCD camera or equivalent imaging forming device 3 for recording the x-ray intensity pattern after the x-rays traverse the body, with or without the use of a phosphor screen 4 that converts x-ray photons into radiation (typically visible) suitable for detection by the CCD.

For the purpose of the present invention optical radiation is defined as laser radiation from the ultraviolet and visible to and the near infrared regions of the spectrum, microwaves, and radio-frequency radiation i.e. any region of the electromagnetic spectrum where absorption contrast between the object of interest and its surroundings is maximal. Additionally, gated image intensifier shall refer to a device that converts x-ray photons to visible photons (with gain) that can be gated on and off electronically, or a device that converts visible photons to visible photons (with gain) and which is electronically switchable.

In a preferred embodiment of the invention the x-ray source is configured in an inline geometry for phase contrast imaging as described by Wilkins and coworkers. The tube is a microfocus x-ray source that produces pulses of x-radiation or is modulated externally to give pulses of x-radiation. The phosphor screen is placed in front of the CCD camera in order to convert the x-ray photons into visible light photons, which are recorded with high efficiency by the CCD camera. A source of optical radiation 5, typically a laser, or one of the radiation sources described above such as microwave source, is directed at the body in one or more places in order to cause heating of regions of the body and to cause the deposition of heat and the ensuing photothermal effects described above. Optical fibers can be used in conjunction with a laser to direct the optical radiation at one or more points of the surface of the body.

The x-ray burst and the optical burst are synchronized so that they illuminate the body at the same time, or at a time when the density gradient or thermal expansion is maximized for creating a change in the normal x-ray pattern at the camera. For this purpose a pulse generator 6 from which the x-ray source and the optical source are synchronized is used. The CCD camera or image recording device is read by a computer 7 and stored, and displayed on a monitor or suitable digital viewing device 8.

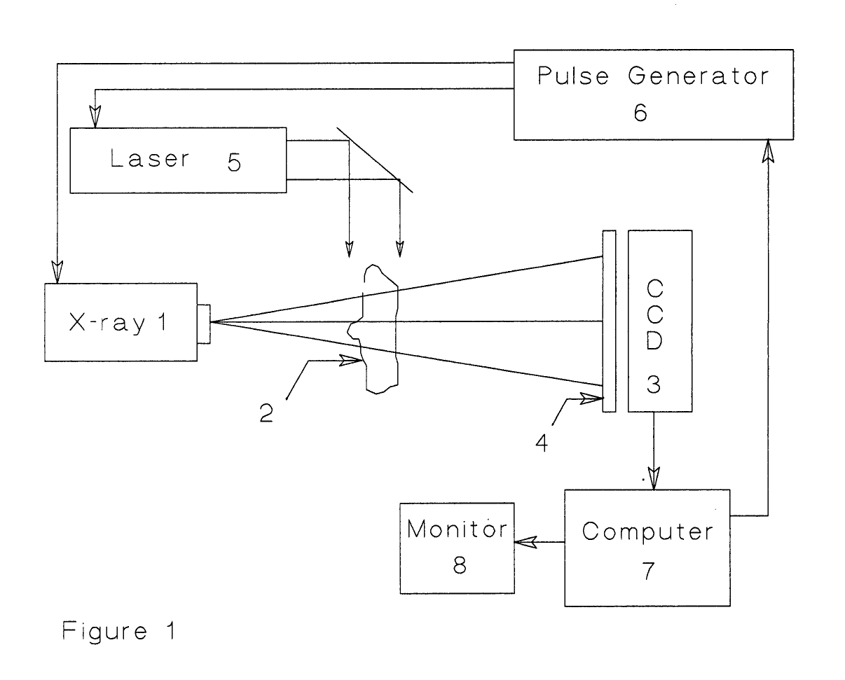

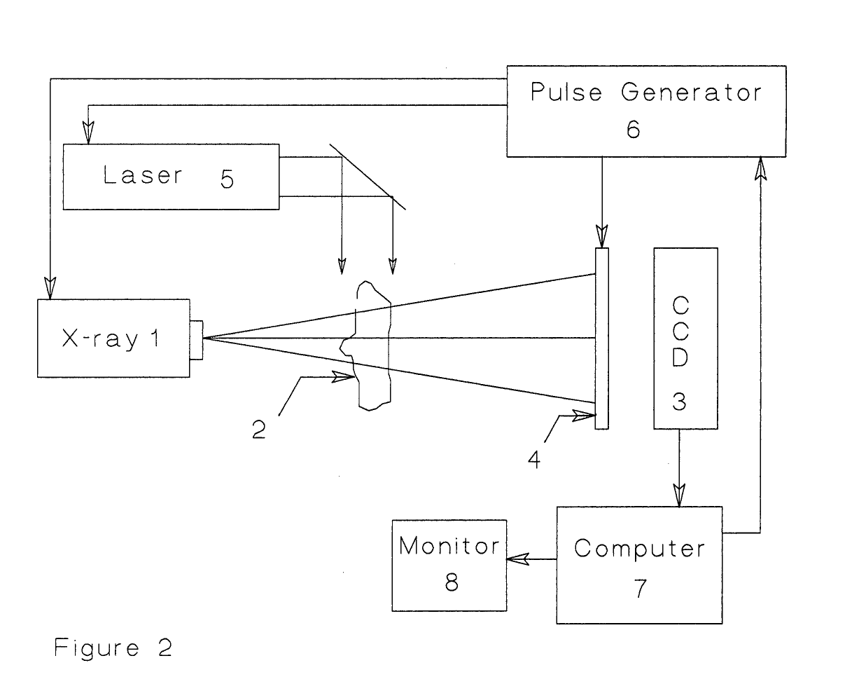

In a second embodiment of the invention, shown in FIG. 2, the components of the device 1 through 8 are the same as in FIG. 1 and as described above, but the phosphor screen is replaced by a gated image intensifier 4 placed in front of the CCD camera or image recording device to provide gating. The gated image intensifier is controlled by the pulse generator to be synchronized with the firing of the laser and the switching on of the x-ray source so that the delay between the firing of the laser and the gating on of the intensifier is optimized to produce the highest contrast in the image.

In a preferred embodiment of the invention two images of the body are made, one employing the optical source synchronized to the x-ray source, and a second image without employment of the optical source. Both images are stored in the computer and subtracted to yield an image of the change induced by the optical radiation.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method of producing an x-ray image comprising:
providing a subject to be imaged;
applying optical radiation to said subject thereby generating temperature and density gradients in said subject; and
x-ray imaging said subject.

2. The method of claim 1 wherein said x-ray image is performed using a method selected from the group consisting of: phase contrast and conventional absorption.

3. The method of claim 1 wherein said subject to be imaged is selected from the group consisting of: tumors, blood, veins and arteries.

4. The method of claim 1, wherein said application of optical radiation creates temperature and density gradients in said subject.

5. A method of producing a composite x-ray image comprising:
providing a subject to be imaged;
applying pulses of optical radiation and x-ray radiation to said subject;
x-ray imaging said subject to form a first image;
applying pulse of x-ray radiation to said subject;
x-ray imaging said subject to form a second image; and
subtracting said first and second images point by point to form a composite x-ray image.

6. The method of claim 5, said step of applying pulses of x-ray radiation consists of applying continuous pulses of x-ray radiation.

7. The method of claim 6, said step of applying pulses of optical radiation consists of applying continuous pulses of optical radiation.

8. The method of claim 5, wherein a gated image intensifier controls the pulses of optical radiation.

9. The method of claim 5 wherein said x-ray image is performed using a method selected from the group consisting of: phase contrast and conventional absorption.

10. The method of claim 5, wherein said subject to be imaged is selected from the group consisting of: tumors, blood, veins and arteries.

11. The method of claim 5, wherein said application of optical radiation creates temperature and density gradients in said subject.

12. A method of producing a composite x-ray image comprising:
providing a subject to be imaged;
applying continuous optical radiation and x-ray radiation to said subject, said optical radiation and said x-ray radiation being in phase relative to one another;
x-ray imaging said subject to form a first image;
applying continuous optical radiation and x-ray radiation to said subject, said optical radiation and said x-ray radiation being out of phase 180 degrees relative to one another;
x-ray imaging said subject to form a second image; and
subtracting said first and second images point by point to form a composite x-ray image.

13. The method of claim 12 wherein said x-ray image is performed using a method selected from the group consisting of: phase contrast and conventional absorption.

14. The method of claim 12, wherein said subject to be imaged is selected from the group consisting of: tumors, blood, veins and arteries.

15. The method of claim 12, wherein said application of optical radiation creates temperature and density gradients in said subject.
